(19) United States
(12) Patent Application Publication
(10) Pub. No.: US 2026/0246845 A1
(43) Pub. Date: Aug. 20, 2026

(54) SYSTEM AND METHOD FOR CROSS-BROWSER WINDOW COMMUNICATION AND TASK HANDLING VIA BROADCAST MESSAGING

(71) Applicant: Palo Alto Networks, Inc., Santa Clara, CA (US)

(72) Inventors: Gokul Ramakrishnan, Mountain House, CA (US); Rosarin Jolly Roy Antonyraj, Santa Clara, CA (US); Ganapathy Subramanian Ramachandran, Sunnyvale, CA (US)

(21) Appl. No.: 19/056,624

(22) Filed: Feb. 18, 2025

(51) Int. Cl. H04L 67/146; G06F 9/451; H04L 67/133; H04L 67/143

(52) U.S. Cl. CPC H04L 67/146; G06F 9/452; H04L 67/133; H04L 67/143

(57) ABSTRACT

The present application discloses a method, system, and computer system for browser window-to-browser window communication. An example of the method includes (i) providing remote access for a session to a cloud entity using a child browser window, and (ii) communicating a message to a plurality of browser windows associated with a main browser window. The message comprises one or more unique identifiers for one or more browser windows. At least one of the plurality of browser windows filters the message based at least in part on the one or more unique browser windows.

### BACKGROUND OF THE INVENTION

In modern web applications, the ability to efficiently manage multiple browser windows and facilitate smooth communication between them is increasingly important. Traditional browser windows or tabs often operate independently, which can make managing tasks across several remote machines or sessions cumbersome. The use of multiple browser windows or popups is common, especially in workflows involving separate tasks, authentication, or user-specific actions. However, managing communication and tasks between a main browser window and its child browser windows becomes increasingly complex, particularly when windows are closed or minimized.

### BRIEF DESCRIPTION OF THE DRAWINGS

Various embodiments of the invention are disclosed in the following detailed description and the accompanying drawings.

FIG. 1A is a block diagram of an environment for providing a browser service to a network according to various embodiments.

FIG. 1B is a block diagram of a system for browser-to-browser communication according to various embodiments.

FIGS. 2A-2F are examples of user interfaces of browser windows.

FIG. 3 is a flow diagram of a method for providing browser window-to-browser window communication according to various embodiments.

FIG. 4 is a flow diagram of a method for processing a communication from a child browser communication associated with a session according to various embodiments.

FIG. 5 is a flow diagram of a method for configuring a child browser window for a particular main browser window according to various embodiments.

FIG. 6 is a flow diagram of a method for communicating with a child browser window according to various embodiments.

FIG. 7 is a flow diagram of a method for communicating with a child browser window according to various embodiments.

FIG. 8 is a flow diagram of a method for communicating with a main browser window according to various embodiments.

FIG. 9 is a flow diagram of a method for communicating with a main browser window according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various embodiments provide a system, method, and device configured to facilitate and enhance communication between multiple browser windows, specifically focusing on interactions between a main browser window and associated child browser windows. Such interactions are commonly encountered in web applications, for example, where a user needs to control or monitor several remote machines through a single web interface. The main browser window acts as a central hub, managing one or more child browser windows that represent individual remote machines or sessions. In many cases, these interactions are crucial for administrative tools, customer support systems, or any application where a user needs to oversee multiple remote environments simultaneously.

The approach implemented by some related art systems use the onbeforeunload( ) event to handle cleanup tasks when a browser window closes, is unreliable because of the time constraints it imposes on task execution. Furthermore, the onbeforeunload( ) event cannot delay browser window closure, which compromises the guarantee of complete task execution. Bidirectional communication between browser windows, where the main browser window can control or query the state of child browser windows and vice versa, is a functionality that is inadequately addressed by related art systems.

In modern web applications, the ability to efficiently manage multiple browser windows and facilitate smooth communication between them is increasingly important. Traditional browser windows or tabs often operate independently, which can make managing tasks across several remote machines or sessions cumbersome.

In current or related art systems, communication between browser windows and triggering events is often based on specific event handlers, such as the onbeforeupload( ) event. The onbeforeupload( ) event is typically used in web applications to handle tasks that need to be performed just before a file is uploaded to a server. This event allows developers to perform actions such as validation, data preparation, or even logging before the upload begins. However, despite its usefulness in certain contexts, the onbeforeupload( ) event does not provide a reliable mechanism for coordinating window actions, particularly when it comes to complex tasks that span multiple browser windows.

An important limitation of related art systems using the onbeforeupload( ) event is that it cannot guarantee the timely completion of tasks, especially when network requests or API calls are involved. For example, if a user is interacting with a child browser window that is responsible for uploading data, and the child browser window is closed before the upload completes or before all associated tasks are finalized, the onbeforeupload( ) event may not have enough time to trigger necessary cleanup or data persistence operations. This can lead to incomplete actions, such as uncommitted data, or even data loss if the child browser window closes abruptly during the execution of network requests.

Moreover, the onbeforeupload( ) event does not have the ability to delay the closure of the child browser window until all necessary tasks are completed. This results in a situation where the browser window might close prematurely, disrupting the completion of critical processes. Because the event is primarily designed for handling file uploads, it is not inherently designed to manage the closure of a browser window or ensure that all cleanup and persistence tasks are completed before a browser window is closed. This limitation can become particularly problematic in scenarios where multiple browser windows or tabs are involved, as tasks in one browser window may depend on the actions of another, and there is no built-in mechanism to enforce synchronization between them.

In other related art systems, communication between browser windows is typically handled using various web technologies, such as JavaScript, postMessage, and custom event listeners. One common approach to triggering events or communication between windows is through the use of the postMessage( ) API, which allows safe cross-origin communication between windows or iframes. This API enables windows to send messages to each other, allowing one window to notify another about a particular event or change in state. For example, a parent window can use postMessage( ) to send data to a child browser window, or a child browser window can use it to notify the parent browser window that an action has been completed.

Although the postMessage( ) API is useful for simple communication, it has limitations in terms of managing complex, synchronized events across multiple browser windows. For example, there is no inherent mechanism in the postMessage( ) API to ensure that a particular browser window has completed its task before another browser window can proceed, making it difficult to implement robust event handling for scenarios where timing is critical, such as coordinating data persistence or network requests across multiple browser windows. Additionally, the postMessage( ) API requires careful attention to security concerns, such as validating the origin of messages to prevent cross-site scripting (XSS) attacks, but even with these precautions, it does not offer built-in guarantees for task completion or synchronization between browser windows.

In contrast to the related art systems, various embodiments address challenges by providing a more robust communication mechanism between browser windows, where tasks can be properly coordinated, and window closures can be delayed to ensure that all necessary actions are performed. In some embodiments, the system uses unique identifiers to facilitate browser window-to-browser window communication, which can thus be used to ensure that events such as window closures can be managed in a way that guarantees the completion of critical tasks, even if network requests or API calls are involved. This approach ensures data integrity and consistent behavior, even in complex, multi-browser window use cases.

According to various embodiments, each child browser window, upon being instantiated, is assigned (e.g., by a process running in the main browser window) a unique identifier, which enables the main browser window to track, communicate with, and manage each child browser window individually or collectively. This communication mechanism ensures that the main browser window can manage the lifecycle of each child browser window, such as bringing it into focus, closing it, or even issuing broadcast messages to a group of child browser windows simultaneously.

This unique identifier-based system also improves the user experience by enabling precise and reliable communication. For instance, if a user needs to control a specific remote machine through a child browser window, the main browser window can address that particular browser window using its unique identifier, avoiding any confusion or miscommunication. The system further enhances its utility by allowing the main browser window to monitor the activities within each child browser window, such by configuring the child browser window to detect user interactions or system events, and report these activities back to the main browser window. This allows for real-time updates and provides the main browser window with a comprehensive understanding of the state of each remote session.

Various embodiments provide a system that facilitates communication between multiple browser windows within a session, for example, by facilitating interactions between a main browser window and one or more child browser windows, such as pop-up windows or tabs. This system is particularly useful in scenarios where a user wants to control remote machines through their browser, with each child browser window representing a different remote machine or session. The main browser window, which acts as the central hub, manages these child browser windows and coordinates the communication between them.

In some embodiments, when a new child browser window is opened, the system (e.g., the main browser window) generates a unique identifier, such as a universally unique identifier (UUID), to associate with that child browser window. This unique identifier is stored in a local cache or table within the main browser window (e.g., in a cache for the main browser window), creating a mapping between the identifier and the corresponding child browser window. This allows the main browser window to efficiently manage and interact with all child browser windows. For example, the main browser window can send a broadcast message to a set of child browser windows, embedding the unique identifiers within the message to ensure the correct recipient or recipients are identified. As another example, the main browser window can send a set of broadcast messages that are each individually configured to have a particular child browser window as the recipient.

In some embodiments, the communication mechanism also allows the main browser window to track and control the lifecycle of each child browser window. For instance, the system can use these identifiers to bring a specific child browser window into focus when required, or to close all child browser windows when the user logs out of the session. This technique can ensure proper management of resources and browser window states, preventing orphaned or unclean sessions. The main browser window may also communicate with the child browser windows to trigger specific actions, such as notifying a child browser window to close or to report certain user activities. In some embodiments, the main browser window can issue broadcast messages with multiple identifiers means that the main browser window can communicate with several child browser windows at once, streamlining interactions and reducing the need for complex individualized messaging. In some embodiments, the main browser window can issues broadcast message with a single identifiers to communicate with a particular child browser windows and the main browser window can configure a plurality of broadcast messages to communicate with a plurality of child browser windows.

In some embodiments, the system uses this communication technique for tracking of activities within the child browser windows. For example, the system can (or cause an applicable child browser window to) detect events such as user interactions (e.g., clicks, scrolls, or form submissions), screen captures, file uploads/downloads, or even security-related events like copy-paste or screen recording. When such events are detected in a child browser window, the child can notify the main browser window via the established communication protocol, triggering further actions or updates. This is particularly useful for monitoring and auditing purposes, as the main browser window can maintain a real-time understanding of the state and activities of all associated child browser windows. This event-driven communication ensures that the system can perform dynamic updates, offer real-time control, and provide seamless user experiences across multiple browser windows or sessions.

Various embodiments improve the functionality and user experience in scenarios where multiple remote machines are being controlled or monitored through a web interface, making it particularly valuable for administrative tools, customer support applications, and other similar use cases.

Various embodiments provide a method, system, and computer system for browser window-to-browser window communication. An example of the method includes (i) providing remote access for a session to a cloud entity using a child browser window, and (ii) communicating a message to a plurality of browser windows associated with a main browser window. The message comprises one or more unique identifiers for one or more browser windows. At least one of the plurality of browser windows filters the message based at least in part on the one or more unique browser windows.

Various embodiments provide a method, system, and computer system for browser window-to-browser window communication. An example of the method includes (i) providing remote access for a session to a cloud entity using a child browser window, (ii) receiving a message from the child browser window, the message comprising an unique identifier for the child browser window and information pertaining to the session, and (iii) updating a cache associated with a main browser window based at least in part on the unique identifier and the information pertaining to the session.

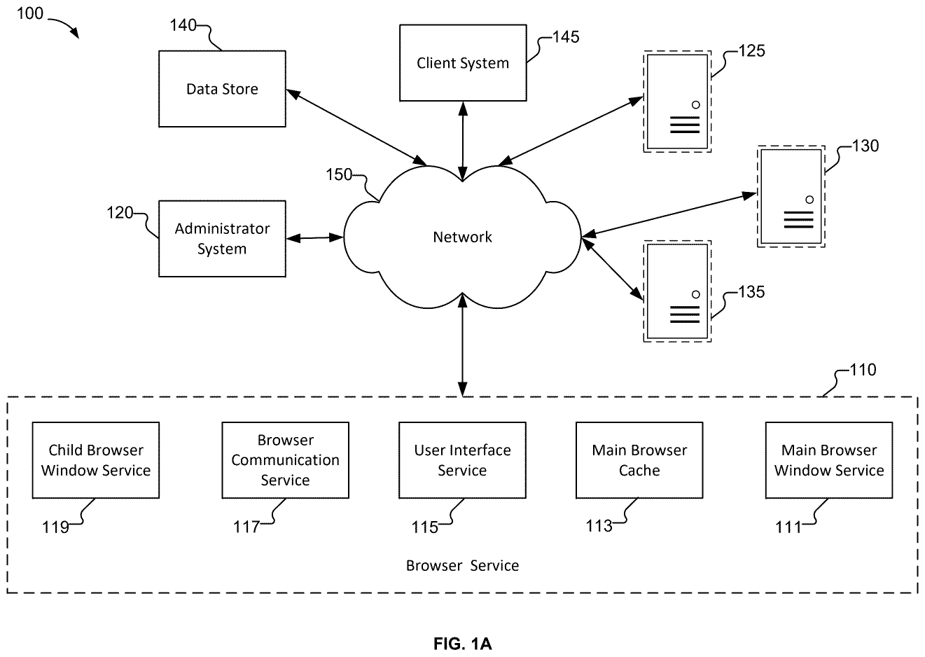

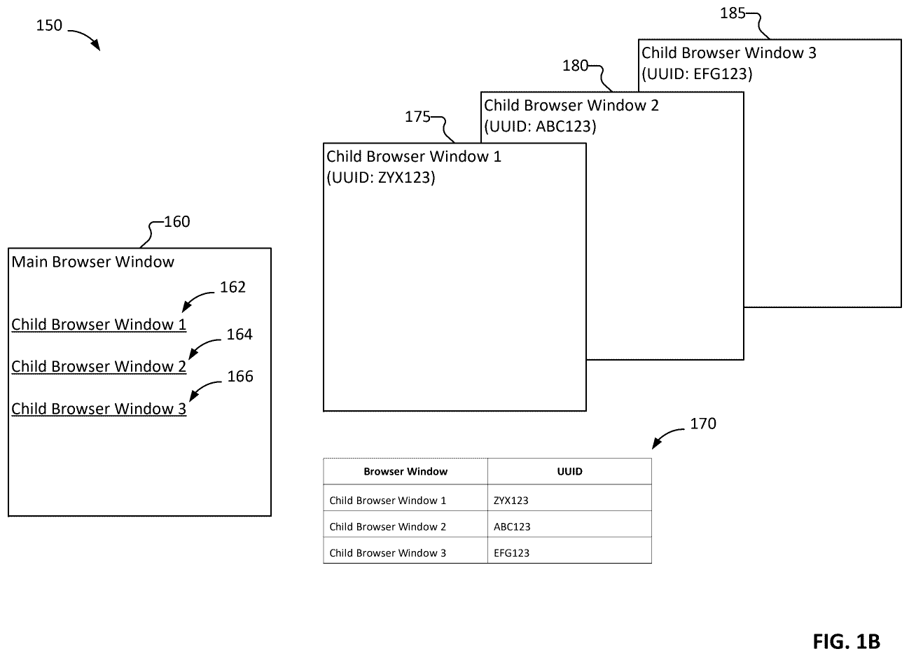

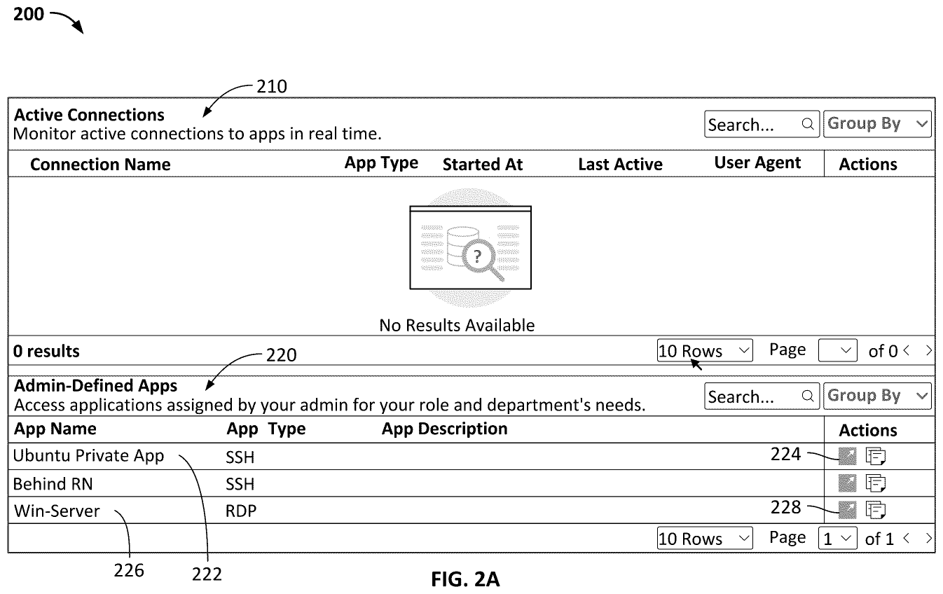

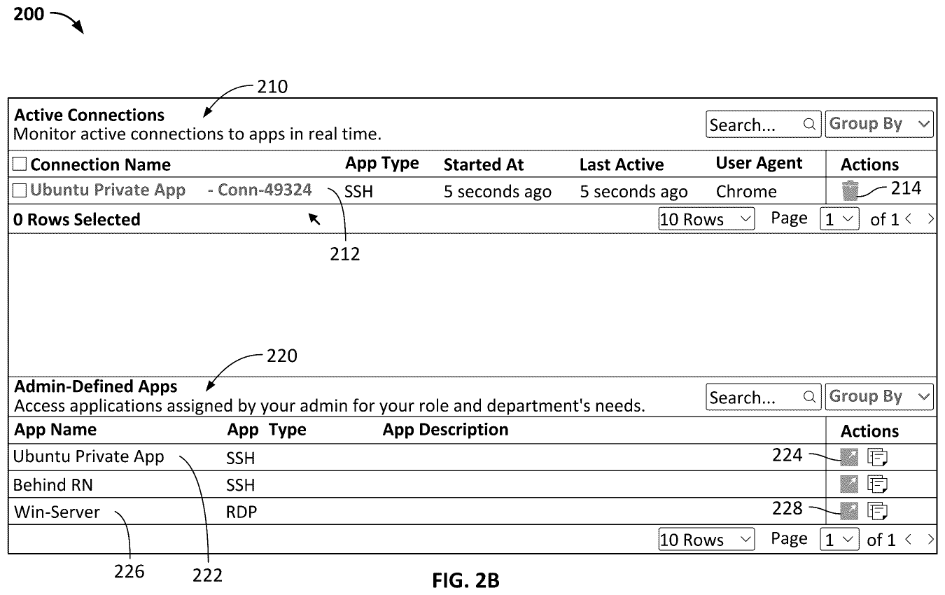

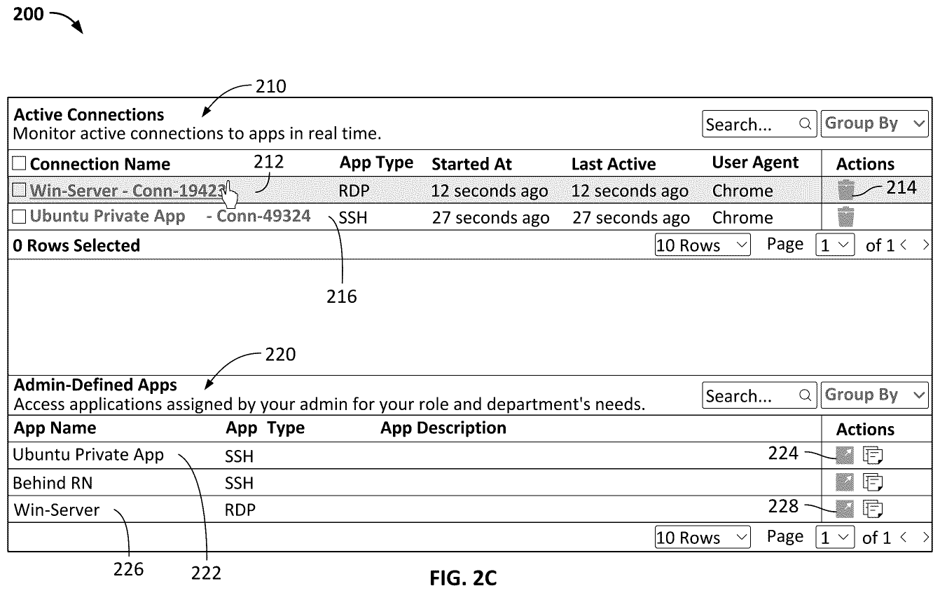

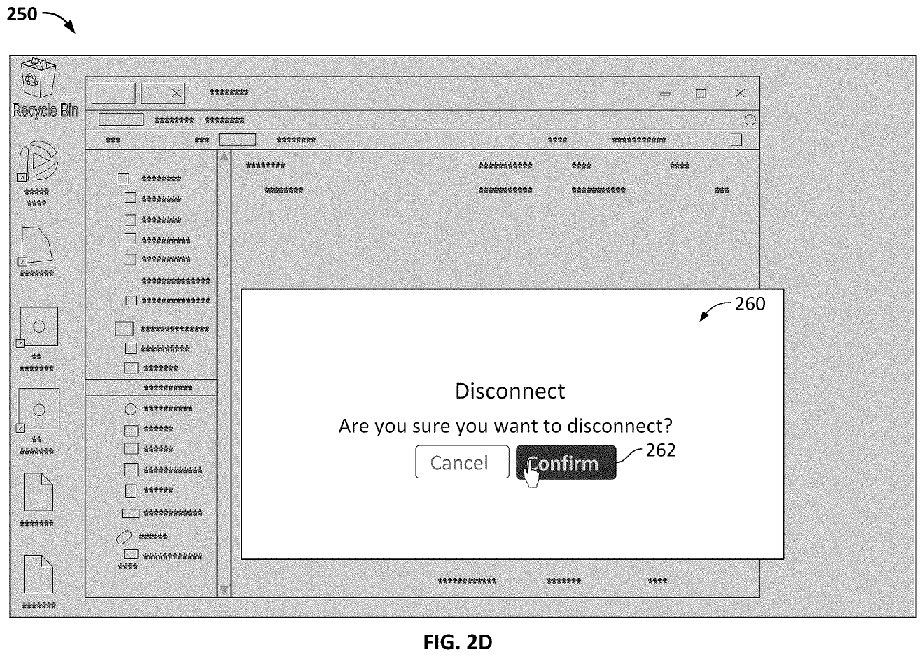

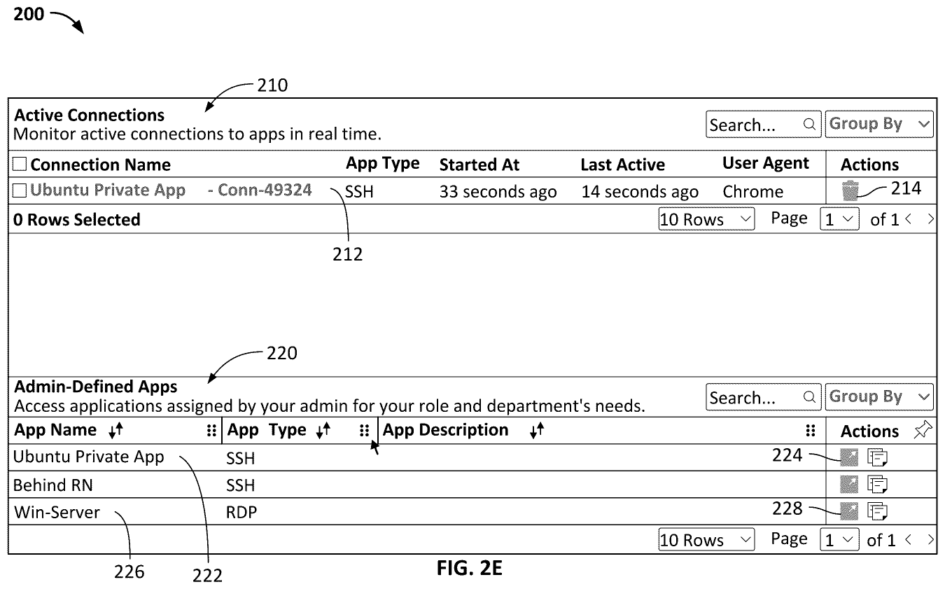

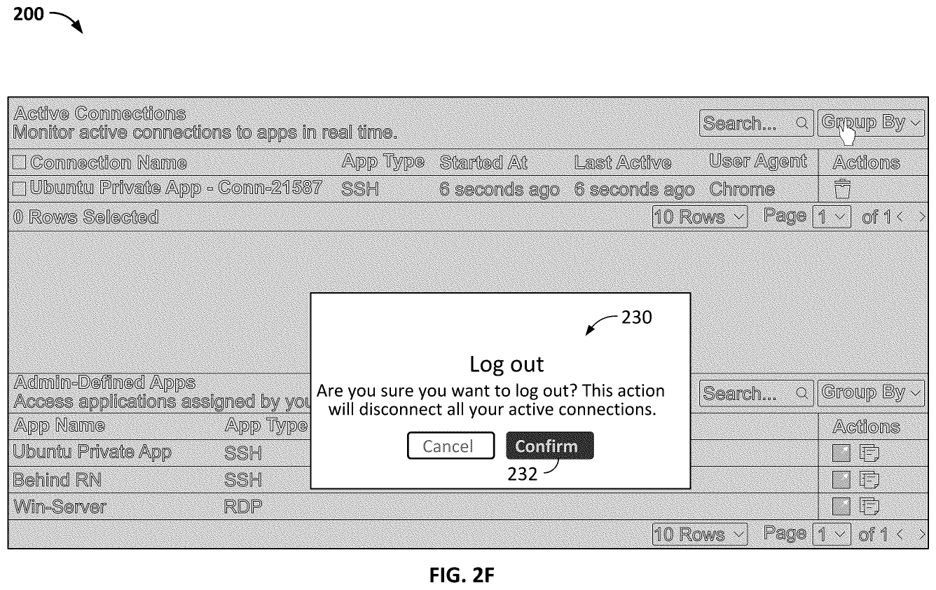

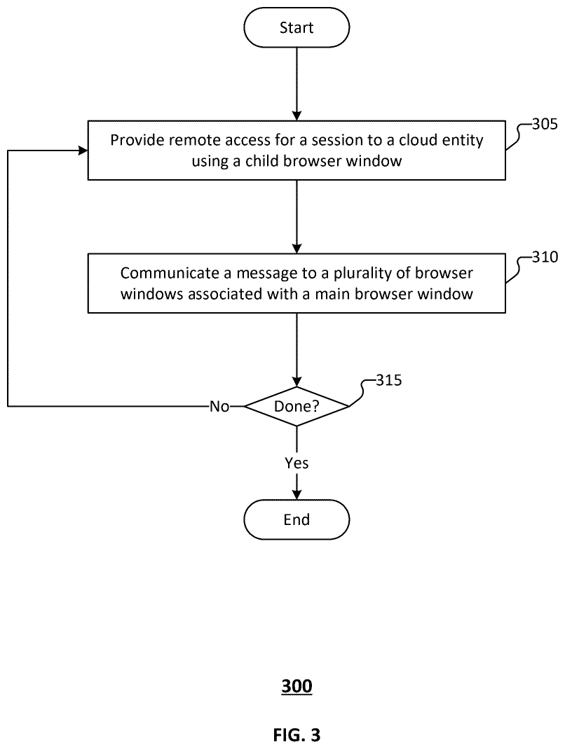

FIG. 1A is a block diagram of an environment for providing a browser service to a network according to various embodiments. FIG. 1B is a block diagram of a system for browser-to-browser communication according to various embodiments. In some embodiments, system 100 may implement one or more of processes 300-900 of FIG. 3-9. In some embodiments, system 100 implements the user interfaces illustrated in FIGS. 2A-2F.

In the example shown, system 100 comprises browser service 110. In some embodiments, browser service 110 can be implemented as a cloud service, such as via one or more servers or virtual machines. In some embodiments, browser service 110 is implemented at a device such as an endpoint, for example, by a browser application.

Browser service 110 is configured to control a browser application/process, for example, to control a main browser window and any associated child browser windows. Browser service 110 can instantiate a main browser window and/or an associated child browser window. In addition, browser service 110 configures/manages browser window-to-browser window communication. Browser service 110 can additionally cause one or more actions to be performed with respect to browser windows.

As illustrated, browser service 110 may include one or more of input main browser window service 111, main browser cache 113, user interface service 115, browser communication service 117, and/or child browser window service 119. In some embodiments, browser service 110 is implemented by a plurality of servers (e.g., providing a remote service, such as a service via which a user can invoke remote control of remote machines). In some embodiments, browser service 110 is implemented by a browser application running on a device, for example, a client system or other endpoint. In various embodiments, network 150 includes one or more of a wired network and/or a wireless network such as a cellular network, a wireless local area network (WLAN), or any other appropriate network. System 100 may include various other systems or terminals.

In some embodiments, browser service 110 comprises main browser window service 111. Browser service 110 uses browser window service 111 to instantiate a main browser window, for example, in connection with a user accessing a service to perform remote control of various remote machines/systems. Main browser window service 111 can control the function of the main browser window, for example, to perform actions with respect to associated child browser windows. Additionally, main browser window service 111 manages associated child browser windows, such as by determining (e.g., generating) unique identifiers for child browser windows, managing a mapping of unique identifiers to child browser windows, monitoring or managing a status child browser windows associated with the main browser window, etc.

According to various embodiments, the determination or generation of a unique identifier for a child browser window is implemented to provide efficient communication and management between the main browser window and its associated child browser windows. When a new child browser window is instantiated, for example, in response to user action such as selecting a specific remote machine to control, the system associates identifiers for the browser windows as a way to uniquely identify this new browser window for subsequent interactions. This unique identifier serves as a reference point that enables the main browser window to track, manage, and communicate with the child browser window as part of the broader multi-window session.

In some embodiments, the system (e.g., main browser window service 111) generates the unique identifier. As an example, the system utilizes a method that ensures the identifier is distinct and unlikely to collide with identifiers assigned to other windows in the same session. A commonly employed technique for generating such identifiers is to use a universally unique identifier (UUID). A UUID is a 128-bit value that can be generated using algorithms designed to ensure uniqueness, even when generated at different times or across different systems. This makes UUIDs particularly suitable for use in browser window management, where many instances of child browser windows may be created in parallel and need to be uniquely identified without risk of duplication.

Upon the generation of the unique identifier (e.g., the UUID) for the child browser window, it is then associated with the child browser window's session. The system may store this UUID in a local cache or table within the main browser window (e.g., a table or other data structure stored in main browser cache 113). This mapping between the unique identifier (e.g., the UUID) and the corresponding child browser window enables the system (e.g., the main browser window) to manage the child browser windows effectively. The table or cache serves as a record of all open child browser windows, ensuring that the main browser window always has an up-to-date list of active child browser windows, which can be used for various purposes, such as sending messages or triggering actions across multiple child browser windows simultaneously.

In addition to ensuring the uniqueness of the identifier, the generation process also involves ensuring that the identifier is easily accessible and usable by both the main browser window and the child browser windows. For instance, once the unique identifier (e.g., the UUID) is generated and associated with the child browser window, the main browser window can use the unique identifier to send broadcast messages to the relevant child browser windows or to bring a specific child browser window into focus. The use of this unique identifier, particularly in combination with a broadcast message, facilitates precise and reliable communication, as each browser window can identify the other by its UUID, eliminating ambiguity in the communication process.

In some embodiments, browser service 110 comprises main browser cache 113. Browser service 110 uses main browser cache 113 to store information pertaining to the main browser window. Main browser cache 113 is configured to store the mapping (e.g., a table or other data structure) of unique identifiers to child browser windows. Main browser cache 113 can further store information pertaining to the child browser windows, such as information that the child browser window reports back to the main browser window. For example, main browser cache 113 can store a state/status of the various child browser windows associated with the main browser window.

According to various embodiments, the main browser window (e.g., main browser window service 111) manages the lifecycle and state of the child browser windows, and one of the ways it achieves this is through maintaining a local cache (e.g., main browser cache 113) that stores relevant information about the associated child browser windows. This cache serves as an internal repository that the main browser window uses to keep track of important data, such as the mapping of unique identifiers (UUIDs) to child browser windows, their current statuses, and any activity or events detected within them. This allows for efficient management and coordination of multiple child browser windows in real-time, ensuring that the main browser window can perform necessary actions or trigger events based on the most up-to-date information.

According to various embodiments, the cache's mapping of unique identifiers to child browser windows is particularly useful in ensuring that the main browser window can reliably identify and communicate with specific child browser windows. Each time a child browser window is instantiated (e.g., by child browser window service 119, for example, at the control/request of main browser window service), the child browser window is assigned a unique identifier, and this identifier is stored in the cache along with any additional details/metadata used in managing the browser window. This may include information such as the browser window's current state, whether it is open or closed, and any active session or task it is handling. By maintaining this mapping, the main browser window can efficiently locate and interact with any given child browser window, whether it's sending a message, bringing the browser window into focus, or performing any other action that requires precise targeting of a specific window.

The cache can store other important information related to the child browser windows, such as their statuses. This status tracking can include whether a particular child browser window is idle, actively processing a task, or waiting for user input. The cache allows the main browser window to continuously/dynamically monitor the state of its child browser windows, which enables the main browser window (e.g., main browser window service 111) to coordinate actions or trigger specific tasks. For instance, if the system needs to close a particular child browser window, the cache can be consulted to ensure that all necessary cleanup tasks or data persistence actions have been completed before the browser window is closed, preventing issues like data loss or incomplete actions.

In some embodiments, main browser window service 111 tracks (and optionally store in the main browser cache 113) any detected activity within the child browser windows. This can provide the main browser window with real-time insights into user interactions and system events. Activity detection can include events such as user clicks, file uploads, form submissions, or even more complex interactions like network requests or screen captures. By storing this information in the cache, the main browser window can remain informed of what is happening within its child browser windows, which is particularly useful in scenarios where multiple browser windows are handling different remote sessions or tasks simultaneously. The system (e.g., browser service 110) can use this activity data to trigger actions or updates in the main browser window, such as notifying the user of progress, issuing additional commands, or triggering specific events based on predefined criteria.

The system may also incorporate additional logic to handle the persistence of the unique identifier. For example, if the child browser window is closed or a new session is initiated, the system (e.g., main browser window service 111) can ensure that the unique identifier is properly de-allocated or reused if necessary, preventing identifier conflicts across sessions. This careful management of the unique identifier ensures that the communication between browser windows remains consistent and reliable throughout the lifetime of the session, even as browser windows are opened, closed, or refreshed.

In some embodiments, manage browser window service 111 manages the lifecycle of the unique identifiers for child browser windows. For example, in response to determining that a child browser window is closed (e.g., that the session/connection associated with the child browser window is terminated/disconnected), manage browser window service 111 can update the main browser cache 113 (e.g., the table or other data structure storing active connections) to remove the entry for the closed browser window. The process of generating and managing a unique identifier for each child browser window is fundamental to enabling effective communication and synchronization between the main browser window and its associated child browser windows. By using a unique identifier and maintaining a consistent mapping of identifiers to browser windows, the system can ensure that all actions, events, and tasks performed within the child browser windows are accurately tracked and managed, leading to a more seamless user experience in scenarios involving multiple concurrent browser windows.

In some embodiments, browser service 110 comprises user interface service 115. Browser service 110 uses user interface service 115 to configure one or more user interfaces, such as a user interface for a main browser window and user interface(s) for any child browser window. As an example, user interface service 115 configures user interface 200 for a main browser window. As another example, user interface service 115 configures user interface 250 for a child browser window.

In some embodiments, browser service 110 comprises browser communication service 117. Browser service 110 uses browser communication service 117 to facilitate browser window-to-browser window communication. For example, a main browser window or a child browser window can use browser communication service 117 to generate a message and to send the message, such as to broadcast the message to all other associated browser windows (e.g., in the case that the main browser window is sending the message, the message is broadcast to all its associated child browser windows).

In some embodiments, browser service 110 comprises child browser window service 119. Browser service 110 uses child browser window service 119 to instantiate a child browser window, such as in response to being invoked by main browser window service (e.g., in response to a user selecting to start a remote session with a remote device, etc.). Child browser window service 119 can be further configured to determine the state for a child browser window and report back its state to the main browser window. In some embodiments, child browser window service 119 is configured to monitor/detect certain activity or event with respect to the child browser window, and in response to detection of the certain activity or event report the activity/event to the main browser window (e.g., via invoking browser communication service 117).

In some embodiments, a user uses a child browser window managed by child browser window service 119 to communicate with another application or device, such as servers 125, 130, and 135. As an example, servers 125, 130, and 135 may be implementing a virtual machine that the user is controlling or accessing via the session with the child browser window.

Administrator system 120 comprises an administrator system for use by an administrator. For example, administrator system 120 comprises a system for communication, data access, computation, etc. An administrator uses administrator system 120 to maintain and/or configure the performance or settings of browser service 110 and/or one or more of data stores (e.g., data store 120). For example, an administrator uses administrator system 120 to start and/or stop services on browser service 110 and/or data store 120, to reboot data store 120, to install software on browser service 110 and/or data store 120, to add, modify, and/or remove data on data store 120, etc. Administrator system 120 communicates with browser service 110 and/or data store 120 via a web-interface. For example, administrator system 120 communicates with browser service 110 and/or data store 120 via a web-browser installed on administrator system 120. As an example, administrator system 120 communicates with browser service 110 and/or data store 120 via an application running on administrator system 120.

According to various embodiments, a user uses system 100 (e.g., a client or terminal, such as client system 140, that connects to browser service 110 via network 150) to define business logic and/or to execute such business logic with respect to data (e.g., one or more datasets) stored on data store 120.

In the example shown in FIG. 1B, system 150 comprises a main browser window 160 and a set of child windows such as child browser window 1 175, child browser window 2 180, and child browser window 3 185. In some embodiments, system 150 is implemented by browser service 110, which can run on an endpoint (e.g., such as client system 145) or a server.

Main browser window 160 manages the set of child browser windows. For example, main browser window 160 comprises indications 162, 164, and 166. Indication 162 corresponds to child browser window 1 175, Indication 164 corresponds to child browser window 180, and indication 166 corresponds to child browser window 186. In some embodiments, indications 162, 164, 166 are selectable elements, such as hyperlinks that bring the corresponding child browser window into focus. According to various embodiments, system 150 (e.g., main browser window 160) stores a mapping of unique identifiers to browser windows, such as in table 170. As an example, main browser window 160 stores and manages table 170 in the local cache for main browser window 160.

FIGS. 2A-2F are examples of user interfaces of browser windows. According to various embodiments, user interfaces 200 and 250 are implemented at least in part by one or more of system 100 of FIG. 1. In some embodiments, user interfaces 200 and 250 is implemented by a browser application running on an endpoint, such as client system 145 of system 100. User interface 200 can be implemented by a main browser window or a process for the main browser window running in a browser application. User interface 250 can be implemented by a child browser window or a process for the child browser window running in a browser application.

According to various embodiments, the system integrates browser window-to-browser window communication based at least in part on configuring an intuitive user interface (UI) displayed in the main browser window. The main browser window acts as the central control hub for the user, allowing the user to manage and interact with multiple remote machines or sessions that are represented by the child browser windows. In some embodiments, the UI in the main browser window is configured to facilitate user actions such as instantiating child browser windows, controlling remote machines, and tracking the status of each child browser window in real-time. Through this interface, the system provides a seamless and efficient way for the user to oversee and manage their various tasks.

Referring to FIG. 2A, user interface 200 comprises an active connections frame 210 and an application control frame 220.

Although FIG. 2A does not include any active connections, active connections frame 210 is configured to comprise one or more entries (e.g., indications) for an active process, such as active child browser windows that have been instantiated. In addition, active connections frame 210 may include one or more selectable elements that the user can use to perform an action with respect to a child browser window (e.g., to control the child browser window).

Application control frame 220 includes one or more entries for applications or services with which the particular user can interact. The set of applications or services that are displayed in application control frame 220 may be configured based on a user permissions, such as a predefined set of applications for which the user has requisite permissions. In the example shown, application control frame 220 comprises a set of applications, including application 222 and application 226. Application control frame 220 additionally includes one or more selectable elements via which the user can invoke an action. For example, the user interface may include a selectable element such as a button or hyperlink that the user can click to initiate the process of gaining control over a specific remote machine. In the example shown, user interface 200 comprises selectable element 224 and selectable element 228. Selectable element 224 may be associated with application 222 (e.g., selection of this element/button can invoke an action with respect to application 222), and selectable element 228 may be associated with application 226.

In some embodiments, when the user selects this selectable element (e.g., selectable element 224 for application 222), the main browser window triggers the creation of a new child browser window. This child browser window, which could represent the remote machine or session being controlled, is instantiated by the main browser window using a unique identifier. As an example, this identifier is passed to the child browser window, ensuring that it can be independently tracked and communicated with later. Through this interaction, the user can seamlessly transition between different remote machines or sessions, all managed within the same main browser window interface.

As an illustrative example, if the user selects selectable element 224, the system configures user interface as shown in FIG. 2B. In this example, active connections frame 210 is configured to comprise an entry 212 (e.g., an indication, hyperlink, etc.) for application 222. Entry 212 may be configured as a hyperlink that can link to the corresponding child browser window. For example, in response to selection hyperlinked entry 212, the child browser window is brought into focus. The main browser window in which user interface 200 is shown can send a communication (e.g., a broadcast message) to the child browser window, such as a function call to bring the child browser window into focus. Active connections frame 210 can be further configured to comprise one or more selectable elements for an entry (e.g., for each particular child browser window), which can be used to invoke an action with respect to the corresponding application/child browser window. In the example shown, active connections frame 210 is configured to comprise selectable element 214. In response to a user selecting selectable element 214, an action is invoked with respect to the child browser window for entry 212. For example, selection of selectable element 214 can cause child browser window to close.

Similarly, selection of selectable element 228 can invoke the instantiation of a child browser window for application 226. In the example shown in FIG. 2C, selection of element 228 has invoked a corresponding child browser window and active connections frame 210 is configured to include entry (e.g., an indication, hyperlink, etc.) for application 226.

In addition to initiating new child browser windows, the main browser window can also display real-time information about the status of each active child browser window. This could be presented in the form of a dashboard or a dedicated section of the user interface (e.g., active connections frame 210) that provides an overview of all active sessions. For instance, the dashboard might display the current status of each child browser window, such as whether it is idle, active, or processing a task. The user can quickly identify the state of each session and take appropriate actions if needed. For example, if a child browser window is no longer needed or the user wishes to terminate a session, they can select an option from the dashboard (e.g., select selectable element 214) to close that specific child browser window. In some embodiments, this action would trigger the communication system to send a broadcast message to the corresponding child browser window, instructing it to close and perform any necessary cleanup tasks.

In some embodiment, in response to using user interface 200 to close a child browser window (e.g., by selecting selectable element 214), the system can cause the corresponding child browser window into focus and child browser window is configured to display user interface 250 with a prompt 260 that requests the user to confirm that disconnection is to be invoked. By selecting confirm button 262 on prompt 260, the user can confirm that the child browser window is to be closed. In other embodiments, the child browser window can be closed directly from user interface 250, such as in the case that the child browser window is in focus when the user determines to disconnect/close the child browser window.

In response to selecting to disconnect a particular session or close a child browser window, the system can configure user interface 200 to remove the application/child browser window as an active connection. In the example shown in FIG. 2E, entry 216 of FIG. 2C is removed from active connections frame 210.

According to various embodiments, the user interface can also allow the main browser window to send commands or request updates from the child browser windows. For example, if the main browser window needs to update a setting or trigger an action within one of the child browser windows, it can do so by sending a broadcast message to the relevant child browser window using its unique identifier. This could include commands such as updating the child browser window's status, requesting information about ongoing tasks, or notifying the child browser window of an impending action, such as logging out or session termination. These actions would be reflected in the user interface in real-time, allowing the user to track the progress of tasks and adjust their interactions accordingly.

Furthermore, the system can enable the main browser window to receive notifications from child browser windows about certain events or activities. For example, if a task in a child browser window is completed, such as a file upload or download, the child browser window can send a message to the main browser window to update the status in the UI. This allows the user to stay informed about the progress of tasks across multiple sessions without having to actively check each child browser window individually. The system's ability to communicate status updates, task completion notifications, and other relevant information directly through the main browser window's interface can help streamline the user experience, making it easier to manage and oversee complex workflows involving multiple remote machines.

In some embodiments, the user can use the main browser window to close all child browser windows. For example, user interface 200 may comprise a selectable element (e.g., button) that enables the user to terminate all active sessions/connections (e.g., close all open/active child browser windows). As another example, the user can invoke the terminate all active sessions/connections (e.g., closing all open/active child browser windows) by selecting to close main browser window. As shown in FIG. 2F, in some embodiments, in response to selecting to terminate all active sessions/connections (e.g., close all open/active child browser windows), user interface 200 can be configured to display 230 which prompts the user to confirm that all active connections are to be disconnected (e.g., all sessions are to be terminated and the corresponding child browser windows are to be closed). In response to selecting confirm button 232, the system can cause all active connections to be disconnected. For example, the main browser window configures and sends a message (or a set of messages) to the child browser windows with an instruction to terminate the connection (e.g., to close the corresponding child browser window).

FIG. 3 is a flow diagram of a method for providing browser window-to-browser window communication according to various embodiments. According to various embodiments, process 300 is implemented at least in part by one or more of system 100 of FIG. 1. In some embodiments, process 300 is implemented by a browser application running on an endpoint, such as client system 145 of system 100.

In some embodiments, process 300 is implemented by system that configures a user interface. For example, process 300 is implemented by a client system. As another example, process 300 may be implemented by a cloud service. In some embodiments, process 300 is implemented by a browser application. For example, process 300 may be implemented by process running in (or in connection with) a main browser window. The system can implement process 300 in connection with instantiating/launching a child browser window.

According to various embodiments, the main browser window can utilize the communication techniques described herein to manage interactions with its associated child browser windows. For example, the system (e.g., the main browser window) uses the communication techniques enabled by the unique identifiers and the local cache to manage interactions with the child browser windows, including coordinating their closure when the main browser window itself is being closed or when the session within the main browser window is terminating. As an example, this can be particularly important in scenarios where the main browser window is managing multiple remote sessions or tasks through its child browser windows, and it is crucial to ensure that all child browser windows are properly closed in an orderly manner, without leaving any sessions incomplete or orphaned.

When the system (e.g., the browser application or a process running in the main browser window) detects that the main browser window is about to close or that the session in the main browser window is terminating, whether due to user action (e.g., based on logging out or closing the window) or system events (e.g., the session being expired), the main browser window can initiate a broadcast communication (e.g., one or more broadcast messages) to all associated child browser windows. Using the unique identifiers stored in the local cache, the main browser window can target each child browser window individually, ensuring that the correct actions are performed for each one. This communication may include instructions to close the child browser windows, perform necessary cleanup tasks, or finalize any outstanding actions before closure.

The system ensures that the child browser windows receive this communication in a timely and reliable manner by leveraging the mapping between the unique identifiers and the active child browser windows stored in the main browser window's cache. When the main browser window issues the command to close the child browser windows, each child browser window can check the broadcast message to determine whether it is the intended recipient by comparing its own unique identifier with those included in the message. Upon identifying that the message pertains to it, the child browser window can then execute the necessary procedures, such as closing the session, saving any data, or notifying the user of the impending closure. In some embodiments, the main browser window configures individual broadcast messages for each of the child browser windows to be controlled (e.g., closed).

The communication system also facilitates the main browser window's ability to ensure that the closure of child browser windows occurs only after all necessary tasks have been completed. For example, if a child browser window is in the middle of an important operation (e.g., such as an upload, form submission, or remote machine control task), the main browser window can delay the closure of that child browser window until the task is finished or the child browser window notifies the main browser window that it is safe to close. As an example, this can prevent the loss of critical data or incomplete actions, addressing a common shortcoming in traditional window management systems that do not have an effective way to synchronize window closure with ongoing tasks.

Additionally, in some embodiments, the main browser window can use this communication technique to inform the child browser windows of the specific reason for their closure, such as the termination of the main session or the user's decision to log out. By providing this context, the system can trigger appropriate responses in the child browser windows, such as saving session data, prompting the user for confirmation, or cleaning up resources. This ensures that the child browser windows properly synchronize with the state of the main browser window and the overall session, leading to a more seamless and reliable user experience.

The communication technique used by the main browser window to trigger the closure of child browser windows in response to session termination or window can be important in maintaining the integrity of the session and preventing data loss or incomplete actions. By leveraging unique identifiers and the local cache, the system can manage the child browser windows efficiently, ensuring that they are properly closed and that all necessary tasks are completed before the session is fully terminated. As an example, this approach can enhance the overall stability and reliability of multi-window interactions, particularly in scenarios where multiple tasks are being managed simultaneously across different browser windows.

In some embodiments, the communication between the main browser window and its associated child browser windows is facilitated using a BroadcastChannel API, which allows for the efficient exchange of messages between windows that share the same origin. This API provides a simple way for windows, tabs, or iframes within the same browser to communicate by sending and receiving messages over a shared channel. Using this communication technique, the main browser window and its child browser windows can easily synchronize their states, send commands, and trigger appropriate actions such as focusing, closing, or updating browser window states in response to specific events or user actions.

In some embodiments, to implement a system that leverages the BroadcastChannel API, both the main browser window and each child browser window establish a BroadcastChannel object that listens to a specific channel. The main browser window and child browser windows each implement an onmessage handler that processes incoming messages from the channel. The handler listens for messages (e.g., broadcast messages) from other browser windows and takes appropriate actions depending on the message contents. For example, when the main browser window determines to send a command to close a particular child browser window, it sends a message via the broadcast channel containing relevant information, such as a command type (e.g., “close”) and the unique identifier of the child browser window. Upon receiving the message, the child browser window's onmessage handler evaluates the content and performs the corresponding action, such as closing the window or saving its state.

Similarly, when a child browser window determines to communicate with the main browser window (e.g., to report the completion of a task or to notify the main browser window of an event) it can send a message over the same broadcast channel. The main browser window, listening for incoming messages, processes these messages and triggers any appropriate actions based on the content. For instance, if a child browser window sends a message indicating that a task has completed, the main browser window may update its state or take action to bring the relevant child browser window into focus. By leveraging the BroadcastChannel API, both the main browser window and child browser windows can ensure that they remain in sync and can perform actions or respond to changes in state in real-time.

The communication model enabled by the BroadcastChannel API also ensures that messages are sent and received in a highly efficient and bidirectional manner. Each browser window listens for incoming messages on the shared channel, and the communication flow is managed asynchronously. For example, browser windows can process messages as they are received without blocking other actions. This facilitates a smooth exchange of messages between the main browser window and the child browser window, ensuring that commands like “focus,” “close,” or “update window state” are promptly executed without unnecessary delays.

In some embodiments, when the main browser window wants to bring a specific child browser window into focus, it sends a “focus” command to the broadcast channel with the unique identifier of the target child browser window. The child browser window, upon receiving this message, compares the identifier in the message with its own and, if they match, brings the window to the forefront. Similarly, when a child browser window determines to notify the main browser window that its session is ending, the child browser window sends a “close” message. The main browser window, upon receiving this message, can take appropriate action, such as updating the session state.

Returning to the example shown in FIG. 3, the system (e.g., the main browser window) can use the communication techniques described herein for the control of child browser windows, such as to bring a child browser window into focus, to close a child browser window, etc. At 305, the system provides a remote access for a session to a cloud entity using a child browser window. For example, a browser application causes a main browser window to open/launch a child browser window to enable a user to have remote access to a cloud entity such as a remote machine (e.g., a virtual machine) or another endpoint. At 310, the system communicates a message to a plurality of browser windows associated with a main browser window. For example, the system (e.g., the main browser window) broadcasts the message to the child browser windows associated with the main browser window. The message may comprise one or more unique identifiers for the one or more child browser windows that are to be controlled or for which the communication is intended. At 315, the system determines whether process 300 is complete. In some embodiments, the system determines process 300 to be complete in response to a determination that no further browser window-to-browser window communication is to be performed, no further child browser windows are to be opened/instantiated, no further child browser windows are to be controlled, no further child browser windows are active, the main browser window has closed, an administrator indicates that process 300 is to be paused or stopped, etc. In response to a determination that process 300 is complete, process 300 ends. In response to a determination that process 300 is not complete, process 300 returns to 305.

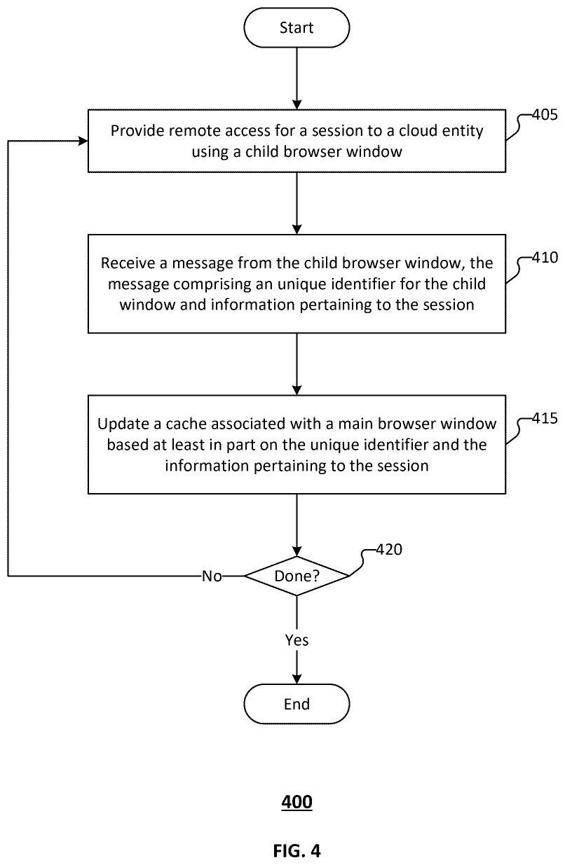

FIG. 4 is a flow diagram of a method for processing a communication from a child browser communication associated with a session according to various embodiments. According to various embodiments, process 400 is implemented at least in part by one or more of system 100 of FIG. 1. In some embodiments, process 400 is implemented by a browser application running on an endpoint, such as client system 145 of system 100.

In some embodiments, process 400 is implemented by system that configures a user interface. For example, process 400 is implemented by a client system. As another example, process 400 may be implemented by a cloud service. In some embodiments, process 400 is implemented by a browser application. For example, process 400 may be implemented by process running in (or in connection with) a main browser window. The system can implement process 400 in connection with communication with a child browser window.

At 405, the system provides a remote access for a session to a cloud entity using a child browser window. For example, a browser application causes a main browser window to open/launch a child browser window to enable a user to have remote access to a cloud entity such as a remote machine (e.g., a virtual machine) or another endpoint. At 410, the system receives a message from the child browser window. The message comprises a unique identifier for the child browser window (e.g., the unique identifier is used in connection with identifying the sender of the message) and information pertaining to the session. Examples of information pertaining to the session that may be communicated back to the main browser window include: an indication that the child browser window is closing or has closed, an indication that a particular activity has occurred at (e.g., with respect to) the child browser window, an indication that a particular user input has been detected, etc. At 415, the system updates a cache associated with the main browser window based at least in part on the unique identifier and the information pertaining to the session. In some embodiments, the main browser window updates its local cache based on the information comprised in the message. The main browser window can receive the message as a broadcast message and determine that it is the intended recipient (e.g., the child browser window may configure the message to include an indication that the recipient is the main browser window based on a unique identifier for the main browser window). As an illustrative example, the message may indicate that the child browser window is closing or that the session is terminating, and the main browser window can correspondingly update its local cache, for example, to remove an entry indicating that the child browser window is an active process. At 420, the system determines whether process 400 is complete. In some embodiments, the system determines process 400 to be complete in response to a determination that no further browser window-to-browser window communication is to be performed, no further child browser windows are to be opened/instantiated, the main browser window has closed, an administrator indicates that process 400 is to be paused or stopped, etc. In response to a determination that process 400 is complete, process 400 ends. In response to a determination that process 400 is not complete, process 400 returns to 405.

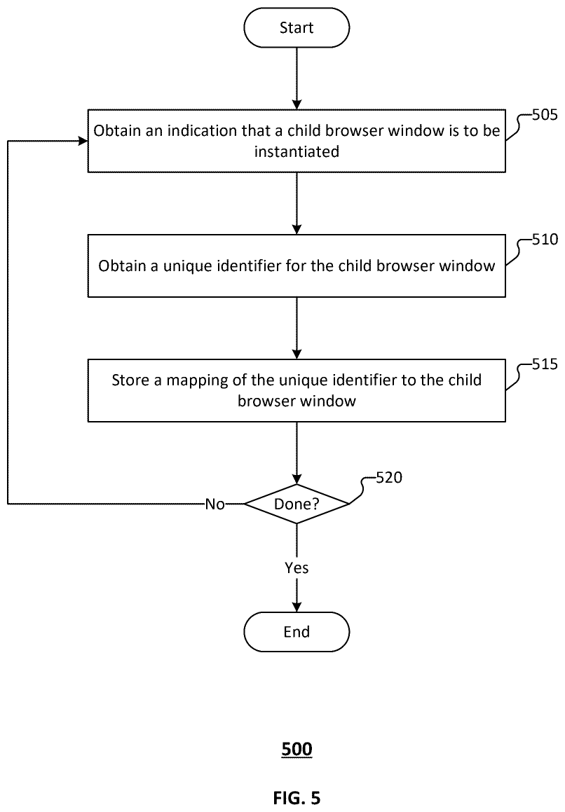

FIG. 5 is a flow diagram of a method for configuring a child browser window for a particular main browser window according to various embodiments. According to various embodiments, process 500 is implemented at least in part by one or more of system 100 of FIG. 1. In some embodiments, process 500 is implemented by a browser application running on an endpoint, such as client system 145 of system 100.

In some embodiments, process 500 is implemented by system that configures a user interface. For example, process 500 is implemented by a client system. As another example, process 500 may be implemented by a cloud service. In some embodiments, process 500 is implemented by a browser application. For example, process 500 may be implemented by process running in (or in connection with) a main browser window. The system can implement process 500 in connection with instantiating/launching a child browser window.

At 505, the system obtains an indication that a child browser window is to be instantiated. For example, the system may obtain the indication in response to a user selecting via a user interface to initiate a session with a remote machine or other endpoint. At 510, the system obtains a unique identifier for the child browser window. In some embodiments, the system generates the unique identifier. For example, the unique identifier is universally unique within the session for at least the main browser window. The unique identifier may be a cryptographically secure unique identifier. In some implementations, the system generates the unique identifier based at least in part on session information. At 515, the system stores a mapping of the unique identifier to the child browser window. In some embodiments, the main browser window (or a process for the main browser window) stores a mapping of the unique identifier to the particular browser window in a local cache, such as a table for child browser windows associated with the main browser window. At 520, the system determines whether process 500 is complete. In some embodiments, the system determines process 500 to be complete in response to a determination that no further browser window-to-browser window communication is to be performed, no further child browser windows are to be opened/instantiated, the main browser window has closed, an administrator indicates that process 500 is to be paused or stopped, etc. In response to a determination that process 500 is complete, process 500 ends. In response to a determination that process 500 is not complete, process 500 returns to 505.

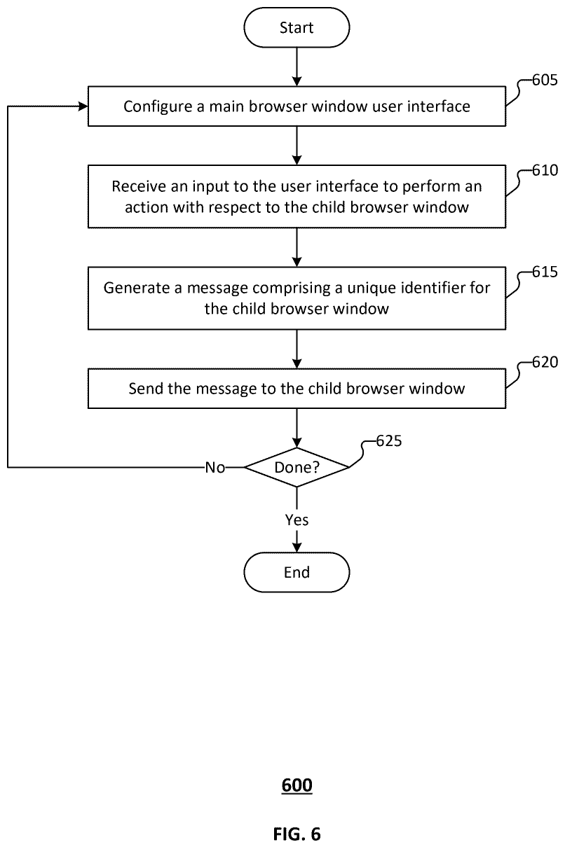

FIG. 6 is a flow diagram of a method for communicating with a child browser window according to various embodiments. According to various embodiments, process 600 is implemented at least in part by one or more of system 100 of FIG. 1. In some embodiments, process 600 is implemented by a browser application running on an endpoint, such as client system 145 of system 100.

In some embodiments, process 600 is implemented by system that configures a user interface. For example, process 600 is implemented by a client system. As another example, process 600 may be implemented by a cloud service. In some embodiments, process 600 is implemented by a browser application. In some embodiments, process 600 is implemented by process running in (or in connection with) a main browser window. The system can implement process 600 in connection with controlling a child browser window, for example, via the main browser window.

At 605, the system configures a main browser window user interface. The user interface may be configured for an application via which a user can control a remote machine. For example, the system can use the user interface to initiate and work in sessions with remote machines (e.g., virtual machines, etc.) or various other endpoints. At 610, the system receives an input to the user interface to perform an action with respect to the child browser window. As an example, the input may be a user selection to initiate a remote session (e.g., in a new child browser window). As another example, the input may be a user selection to close a particular child browser window, or in some cases, all child browser windows associated with the main browser window. As another example, the input may be a user selection to bring a particular child browser window into focus. At 615, the system generates a message comprising a unique identifier for the child browser window with respect to which the action is to be performed. At 620, the system sends the message to the child browser window. As an example, the system (e.g., the main browser window) broadcasts the message, which the applicable child browser window(s) can parse to determine whether the message applies to it. At 625, the system determines whether process 600 is complete. In some embodiments, the system determines process 600 to be complete in response to a determination that no further browser window-to-browser window communication is to be performed, no further child browser windows are open/instantiated, the main browser window has closed, an administrator indicates that process 600 is to be paused or stopped, etc. In response to a determination that process 600 is complete, process 600 ends. In response to a determination that process 600 is not complete, process 600 returns to 605.

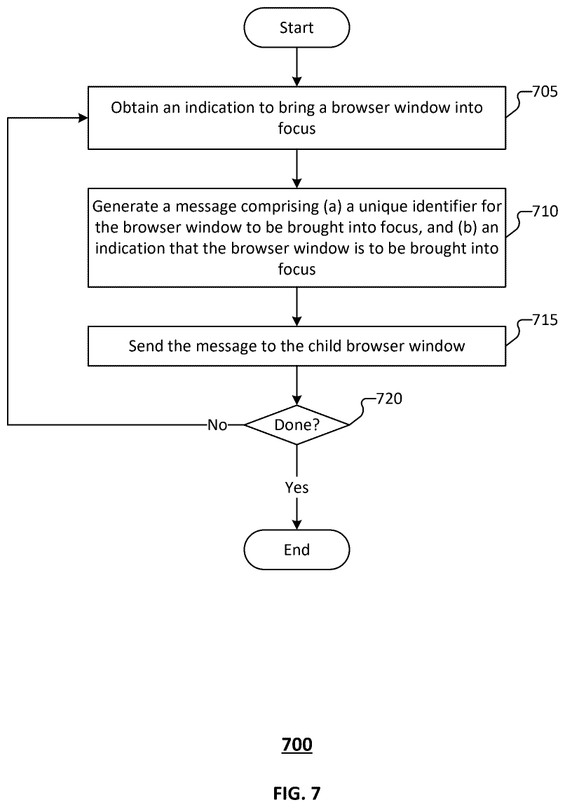

FIG. 7 is a flow diagram of a method for communicating with a child browser window according to various embodiments. According to various embodiments, process 700 is implemented at least in part by one or more of system 100 of FIG. 1. In some embodiments, process 700 is implemented by a browser application running on an endpoint, such as client system 145 of system 100.

In some embodiments, process 700 is implemented by a browser window, such as a process running in (or in connection with) the main browser window. A similar process may be implemented by a child browser window. The system can implement process 700 in connection with implementing a focus control, such as to bring another browser window into focus.

According to various embodiments, the main browser window can use the communication techniques described herein (e.g., a communication technique implemented at least in part on the BroadcastChannel API) to manage focus control over its associated child browser windows, even when these child browser windows are minimized, hidden, or otherwise not currently in the foreground. This capability is particularly important in applications where the main browser window acts as a central hub for managing multiple child browser windows that each correspond to different remote tasks or sessions. As an example, the main browser window uses a combination of the BroadcastChannel API and the unique identifiers (e.g., the unique identifier for the child browser window browser to be impacted by the focus control, such as to bring into focus, or to minimize) passed into the window.open( ) function, the main browser window can efficiently bring a specific child browser window into focus which can facilitate a seamless user interaction across multiple windows.

In some embodiments, when a child browser window is opened by the main browser window using window.open( ), the main browser window assigns a unique identifier to the child browser window. The main browser window can pass this unique identifier for the child browser window as a parameter when calling the window.open( ) method. This unique identifier serves as a key reference for the main browser window to locate, communicate with, and/or control the child browser window later. As an example, even if the child browser window is minimized or not visible on the screen, the main browser window can use the unique identifier for the child browser window to send a broadcast message to bring that specific browser window into focus. In some embodiments, the main browser window's BroadcastChannel object allows the main browser window to send messages to its associated child browser windows. These messages (e.g., broadcast messages) are configured to include the unique identifiers of the browser windows that are to be focused. In some embodiments, the child browser window can determine whether it should come to the foreground based on receiving a message (e.g., a broadcast message) from another browser window (e.g., the main browser window).

When the broadcast message is received by a child browser window, the onmessage handler in that child browser window evaluates the unique identifier included in the message. If the unique identifier matches the one assigned to the child browser window, the browser window can then execute the appropriate actions to bring itself into focus, such as using browser-specific APIs or modifying its z-index to ensure it appears on top of other windows. Accordingly, the main browser window can use this communication technique to effectively manage which child browser window is in the foreground, even if the child browser window was previously minimized or hidden behind other windows.

The use of this communication technique for focus control is especially valuable in environments where multiple tasks are being carried out simultaneously across different browser windows. For example, if the main browser window is overseeing several remote machines or sessions, and the user needs to interact with one of the child browser windows, the main browser window can dynamically bring the relevant child browser window into focus based on user input or session status changes. This eliminates the need for the user to manually navigate between windows or tabs, improving both efficiency and user experience.

Moreover, by leveraging the unique identifier passed into window.open( ), the main browser window can ensure that the correct window is brought into focus, even when dealing with numerous child browser windows. This system provides a robust method for managing focus in multi-window environments, where the main browser window acts as the orchestrator of actions across its child browser windows, ensuring that the right browser window is always brought into view at the appropriate moment. This approach also maintains consistency and reliability across the user interface, preventing errors or confusion that might arise if focus were not properly managed across multiple windows.

The system (e.g., the main browser window) can use this communication technique in connection with controlling child browser windows (e.g., to control their behavior, such as to close the associated child browser windows). When the user logs out of a session in the main browser window, it is important that the associated child browser windows also properly terminate their sessions to maintain consistency and prevent any orphaned processes or resources. According to various embodiments, to achieve this, the main browser window can utilize the communication technique described herein to communicate with the child browser windows and cause the child browser windows to close/terminate. As an example, the main browser window can implement the BroadcastChannel API to broadcast a logout message to all associated child browser windows. By leveraging the unique identifiers assigned to each child browser window, the main browser window can ensure that every child browser window correctly handles its own closure in response to the logout event, for example, even if some child bowser windows are running tasks or hidden from view.

In some embodiments, upon detecting the user's logout action, such as through a button click or session expiration, the main browser window generates a broadcast message indicating that a logout event has occurred. As an example, this broadcast message is sent via the BroadcastChannel API, and it includes a command to log out, as well as the unique identifiers of all active child browser windows. As another example, the main browser window can communicate a plurality of broadcast messages with each of the plurality of broadcast messages comprising a unique identifier of a child browser window, for example, to ensure that each child browser window receives a broadcast message matching its unique identifier and causing the child browser window to close/terminate/logout. Each child browser window, upon receiving the message, uses its unique identifier to determine whether it is the intended recipient of the broadcast message. If the identifier matches, the child browser window determines that it should initiate the necessary steps to terminate its session and close itself. This can include saving any final data, notifying the user of the session end, or performing any other cleanup tasks before the window closes.

The use of unique identifiers can ensure that each child browser window is independently able to determine its role in the logout process. Even if there are multiple child browser windows open, some of which might be performing background tasks or have different levels of visibility, each browser window will only respond to the logout message if the unique identifier matches its own. This ensures that no browser window is inadvertently left open or closed prematurely, preventing any data loss or incomplete session terminations. Furthermore, because the broadcast message is received asynchronously, the main browser window can ensure that the logout message is propagated to all relevant child browser windows, ensuring proper synchronization across the session.

In addition to simply closing the child browser windows, the system can allow the main browser window to manage any final interactions with the child browser windows before they are closed. For example, the child browser windows may be required to notify the main browser window of any unsaved data or ongoing tasks that need to be completed before termination. The main browser window can use this information to ensure that all critical actions are finalized before initiating the logout process. As an example, the main browser window can use the BroadcastChannel API to handle this communication, thereby allowing the main browser window to trigger a smooth and coordinated logout procedure across all child browser windows, ensuring a clean exit from the session.

Returning to the example shown in FIG. 7, the system (e.g., the main browser window) can use the communication techniques described herein for focus control of child browser windows, such as to bring a child browser window into focus. At 705, the system obtains an indication to bring a browser window into focus. At 710, the system generates a message, for example, a broadcast message to communicate with another browser window(s). In some embodiments, the message comprises a unique identifier for the browser window (e.g., the child browser window) to be brought into focus, and an indication that the particular browser window is to be brought into focus. At 715, the system sends the message to the child browser window. In some embodiments, the system sends the message by broadcasting the message to the various child browser windows associated with the main browser window. In response to the particular child browser window determining that it has a unique identifier matching the broadcasted message, the particular child browser determines that it is an intended recipient of the message and performs the corresponding action, etc. At 720, the system determines whether process 700 is complete. In some embodiments, the system determines process 700 to be complete in response to a determination that no further browser window-to-browser window communication is to be performed, the particular child browser window has been brought into focus, no further focus control is to be implemented, the main browser window has closed, an administrator indicates that process 700 is to be paused or stopped, etc. In response to a determination that process 700 is complete, process 700 ends. In response to a determination that process 700 is not complete, process 700 returns to 705.

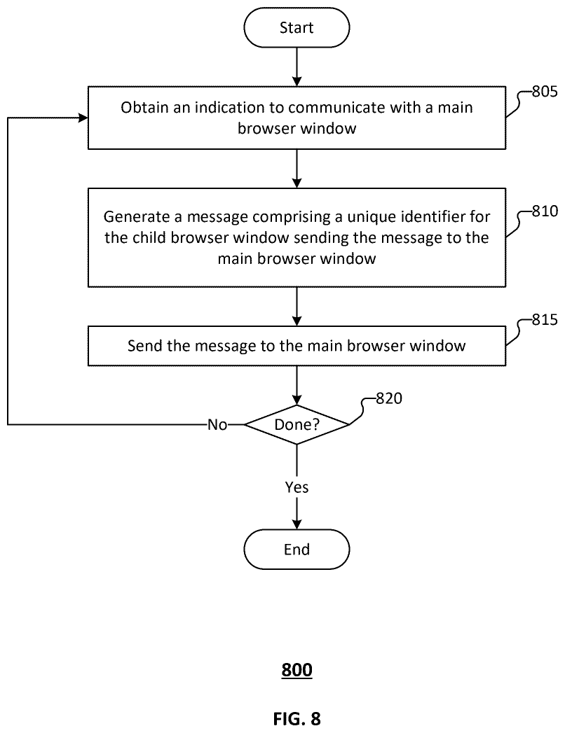

FIG. 8 is a flow diagram of a method for communicating with a main browser window according to various embodiments. According to various embodiments, process 800 is implemented at least in part by one or more of system 100 of FIG. 1. In some embodiments, process 800 is implemented by a browser application running on an endpoint, such as client system 145 of system 100.

In some embodiments, process 800 is implemented by a child browser window, such as a process running in (or in connection with) the child browser window. The system can implement process 800 in connection with providing to a main browser window information pertaining to activity at the child browser window.

When a child browser window is closed, it is important to ensure that any necessary cleanup actions are performed to maintain the integrity of the session and ensure that the main browser window is aware of the updated state. In some embodiments, the system uses the communication technique described herein (e.g., the mechanism provided by the BroadcastChannel API) to facilitate this cleanup process. The system (e.g., the child browser window) can detect that it is to be closed, for example, in response to detecting a user input to close the window, to terminate a session associated with the child browser window (e.g., a session with a remote machine for which the child browser window was instantiated), etc. In connection with the closing of the child browser window closes, the child browser window sends a broadcast message to the main browser window, notifying it that the child browser window has been closed and that any associated tasks or sessions should be updated accordingly. As an example, this notification/alert that the child browser window ensures that the main browser window's internal state remains synchronized with the actual state of the child browser windows.

According to various embodiments, upon receiving the broadcast message from the child browser window, the main browser window uses the unique identifier associated with the child browser window to identify which specific browser window has been closed. The main browser window then updates its internal table or cache, which keeps track of all active child browser windows, ensuring that the list of open child browser windows is always up-to-date. This table (or other data structure in the main browser window cache), maintained in the main browser window's memory, maps each child browser window's unique identifier to its corresponding browser window. When a child browser window closes, the main browser window simply removes the corresponding entry from this table, reflecting the change in real-time.

This cleanup mechanism can ensure that the main browser window (e.g., always) has an accurate view of which child browser windows are still active. Without this communication, the main browser window might mistakenly try to interact with a child browser window that no longer exists or fail to recognize that a session has been terminated. The broadcast message sent by the child browser window serves as a form of notification to the main browser window, which can then take the appropriate actions to update its state, whether it is for display purposes, session management, or triggering other dependent actions.

In some embodiments, the system (e.g., the main browser window) also ensures that any resources or data associated with the child browser window are properly managed. For example, the child browser window may report back to the main browser window that it has completed or saved its tasks before closing. In some embodiments, the child browser window can include additional information in the communication (e.g., a broadcast message), such as confirmation of data persistence or the status of an ongoing task. The main browser window, upon receiving this communication (e.g., the broadcast message), can check the status and ensure that appropriate (e.g., all necessary) cleanup tasks are completed before fully updating the list of open child browser windows. This approach minimizes the risk of data loss or incomplete tasks, providing a seamless experience even when multiple child browser windows are involved.

In some embodiments, the system (e.g., the applicable browser window) communicates with another browser window(s) based at least in part on using the BroadcastChannel API. For example, the child browser window implements BroadcastChannel API to handle this child browser window closure cleanup. This technique enables the system ensures that communication is handled asynchronously and efficiently, allowing both the main browser window and child browser windows to remain in sync. As a result, the main browser window maintains an accurate and up-to-date list of active child browser windows, ensuring that the overall session state is correctly managed throughout the user's interaction with the application.

Returning to the example shown in FIG. 8, the system (e.g., a child browser window) can use the communication techniques described herein to provide information to the main browser window, for example, to report to the main browser window that the child browser window is being closed/terminated. At 805, the system obtains an indication to communicate with a main browser window. In some embodiments, the system (e.g., the child browser window) determines to communicate with the main browser in response to determining that the child browser window is closing, the session for the child browser window (e.g., the session with the remote machine for which the child browser window is instantiated), etc. At 810, the system generates a message (e.g., a broadcast message) based at least in part on a unique identifier associated with the child browser window. For example, the system inserts the unique identifier into the message. In some embodiments, the unique identifier inserted into the message is the unique identifier for the browser window that sends the communication to the main browser window. At 815, the system sends the message to the main browser window. In some embodiments, the system (e.g., the child browser window) broadcasts the message to all browser windows, and the main browser window receives the broadcast message and determines that the main browser window is an intended recipient of the broadcast message. At 820, the system determines whether process 800 is complete. In some embodiments, the system determines process 800 to be complete in response to a determination that no further browser window-to-browser window communication is to be performed, the session for the main browser window has been terminated, the main browser window has closed, an administrator indicates that process 800 is to be paused or stopped, etc. In response to a determination that process 800 is complete, process 800 ends. In response to a determination that process 800 is not complete, process 800 returns to 805.

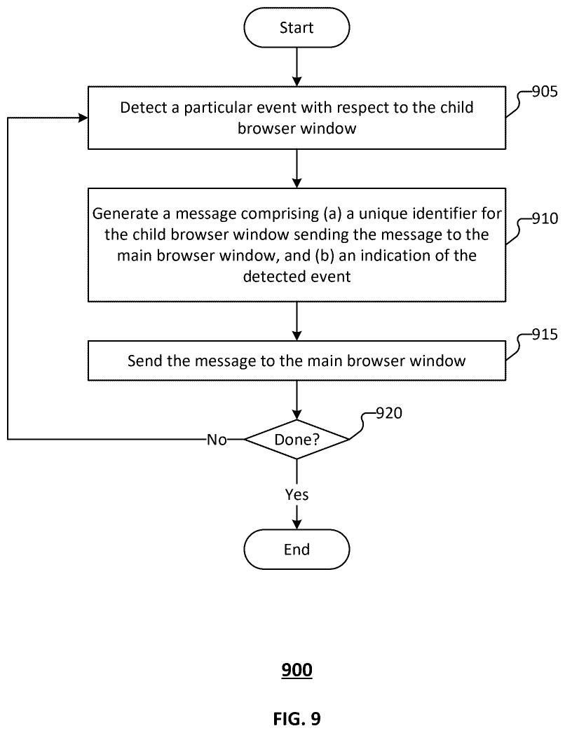

FIG. 9 is a flow diagram of a method for communicating with a main browser window according to various embodiments. According to various embodiments, process 900 is implemented at least in part by one or more of system 100 of FIG. 1. In some embodiments, process 900 is implemented by a browser application running on an endpoint, such as client system 145 of system 100.

In some embodiments, process 900 is implemented by a child browser window, such as a process running in (or in connection with) the child browser window. The system can implement process 900 in connection with providing to a main browser window information pertaining to activity at the child browser window.

According to various embodiments, the communication technique (e.g., facilitated by the BroadcastChannel API) enables child browser windows to report back to the main browser window whenever certain activities or events are detected within the child browser window. This technique ensures that the main browser window is kept informed of important events or actions occurring in the child browser windows, even if the main browser window is not actively focused or directly interacting with those child browser windows at the time. For example, the child browser window can send the message to the main browser window via a broadcast message. By sending broadcast messages to the main browser window, the child browser windows can notify it of key activities, triggering appropriate responses or actions to ensure that the session remains consistent and up-to-date.

One example of such activity is when a child browser window is closed. The system can detect the closure of a child browser window and have the child browser window send a message (e.g., a broadcast message) to the main browser window. This message includes the unique identifier of the closed child browser window, allowing the main browser window to update its internal state, for example, to remove the child browser window's entry from the list of active browser windows in the main browser window's table. This ensures that the main browser window always has an accurate view of the active child browser windows and can prevent attempts to interact with closed browser windows. Similarly, when a child browser window is minimized or loses focus, it can notify the main browser window, allowing the system to maintain synchronization across all browser windows.

According to various embodiments, the system is configured to detect various other critical events within a child browser window and reported back to the main browser window. For example, if a child browser window detects a screenshot being taken, it can send a message to the main browser window to alert the main browser window of this activity. This is particularly useful in environments where data security and user privacy are important, because this mechanism allows the main browser window to track potential sensitive actions that may occur within the child browser window. Similarly, according to some embodiments, if a file upload or download is initiated within the child browser window, the child browser window can notify the main browser window of the event (e.g., using the communication techniques described herein, such as via a broadcast message), providing real-time updates on the progress of the operation. This allows the main browser window to track the completion status of various tasks, which can be important for monitoring and managing the overall session.

Other types of activities that the system (e.g., the child browser window) can monitor and report back include clipboard interactions, such as copy and paste actions. If a user copies data from a child browser window or pastes data into the browser window, the system can trigger a message to the main browser window to inform the main browser window of the action. This can be especially useful for tracking data flow between different devices or applications, ensuring that sensitive information is not inadvertently transferred or mishandled. Similarly, in some embodiments, the system (e.g., the child browser window) can similarly monitor/detect screen recording actions/events. In response to detecting a screen recording (e.g., if it detects that screen recording software is active), the child browser window can report the screen recording action/event back to the main browser window. By alerting the main browser window of such events, the system helps ensure that potential security risks or policy violations are identified and the system can address these risk or policy violations in real-time.

According to various embodiments, the system can monitor and report various other types of user interactions that may be relevant for session management or security. For example, the detection of specific user inputs, such as form submissions or the clicking of certain buttons, can be sent back to the main browser window to update session state or trigger further actions. The system could also track network activity within the child browser window, such as whether the child browser window is actively communicating with a remote server, and report back to the main browser window on the status of those network requests. This can enable the main browser window to stay informed of the child browser window's activities, making it possible to manage and coordinate complex, multi-window workflows or remote sessions more effectively.

Returning to the example shown in FIG. 9, the system (e.g., a child browser window) can use the communication techniques described herein to provide information to the main browser window, for example, to report to the main browser window that a particular event has occurred or to report back activity (e.g., user activity) with respect to the child browser window. At 905, the system detects a particular event with respect to the child browser window. The system can monitor behavior of a child browser window and/or an interaction (e.g., a user interaction) with the child browser window. For example, the system monitors the child browser window for a set of one or more predefined events or actions. At 910, the system generates a message comprising (a) a unique identifier for the child browser window sending the message to the main browser window, and (b) an indication of the detected event. At 915, the system sends the message to the main browser window. In some embodiments, the system sends the message to the main browser window using the techniques described herein. For example, the client browser window broadcasts the message, which the main browser window can receive. In response to receiving the broadcasted message, the main browser window may determine that it is the intended recipient of the message and process the message accordingly. At 920, the system determines whether process 900 is complete. In some embodiments, the system determines process 900 to be complete in response to a determination that no further browser window-to-browser window communication is to be performed, the session for the main browser window has been terminated, the main browser window has closed, an administrator indicates that process 900 is to be paused or stopped, etc. In response to a determination that process 900 is complete, process 900 ends. In response to a determination that process 900 is not complete, process 900 returns to 905.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

WHAT IS CLAIMED IS:

1. A system, comprising:
one or more processors configured to:
provide remote access for a session to a cloud entity using a child browser window; and
communicate a message to a plurality of browser windows associated with a main browser window;
wherein:
the message comprises one or more unique identifiers for one or more browser windows; and
at least one of the plurality of browser windows filters the message based at least in part on one or more unique browser windows; and
a memory coupled to the one or more processors and configured to provide the one or more processors with instructions.

2. The system of claim 1, wherein the child browser is a pop-up browser window based on a user interaction with the main browser window.

3. The system of claim 1, wherein the child browser window is instantiated when the session with the cloud entity is initiated.

4. The system of claim 1, wherein the one or more processors are further configured to:
determine that the session to the cloud entity is to initiated;
assign a unique identifier to the session; and
instantiate the child browser window, wherein the unique identifier is stored in association with the child browser window.

5. The system of claim 4, wherein the unique identifier is stored in association with the child browser window in a cache associated with the main browser window.

6. The system of claim 1, wherein the child browser window and the main browser window are configured for bidirectional communication.

7. The system of claim 6, wherein the main browser window communicates the message as a broadcast message.

8. The system of claim 7, wherein in response to receiving the broadcast message, the plurality of browser windows associated with the main browser window filter the broadcast, based on the one or more unique identifiers comprised in the browser message.

9. The system of claim 7, wherein in response to receiving the broadcast message, each particular browser window of the plurality of browser windows determine whether the broadcast message is intended for the particular browser window based at least in part on the one or more unique identifiers comprised in the browser message.

10. The system of claim 1, wherein the child browser window sends the message to the main browser window in connection with a termination of the session.

11. The system of claim 1, wherein the child browser inserts into the message the unique identifier associated with the child browser, and the main browser window performs an actions with respect to the child browser window based at least in part on the unique identifier.

12. The system of claim 1, wherein the child browser window sends the message to the main browser window in connection with offloading one or more tasks to the main browser window in the event that the child browser window is closed.

13. The system of claim 12, wherein in response to determining that the child browser window is closed, the main browser window updates a local cache to remove information pertaining to the child browser.

14. The system of claim 1, wherein the message is used in connection with the main browser window tracking user activity in the child browser window.

15. The system of claim 1, wherein the main browser window sends the message to the child browser window in connection with determining that the child browser window is active.

16. The system of claim 1, wherein the child browser window is configured to broadcast to the main browser window a message in response to detecting a particular user activity within the child browser window.

17. The system of claim 1, wherein the message is used in connection with bringing the child browser window into focus.

18. The system of claim 1, wherein in response to a determination that a particular session for the main browser window is terminated, one or more messages are communicated to any child browser windows associated with the main browser window to cause the child browser windows to automatically close.

19. A method, comprising:
providing remote access for a session to a cloud entity using a child browser window; and
communicating a message to a plurality of browser windows associated with a main browser window,
wherein:
the message comprises one or more unique identifiers for one or more browser windows; and
at least one of the plurality of browser windows filters the message based at least in part on one or more unique browser windows.

20. A computer program product embodied in a non-transitory computer readable medium and comprising computer instructions for:
providing remote access for a session to a cloud entity using a child browser window; and
communicating a message to a plurality of browser windows associated with a main browser window,
wherein:
the message comprises one or more unique identifiers for one or more browser windows; and
at least one of the plurality of browser windows filters the message based at least in part on one or more unique browser windows.

21. A system, comprising:
one or more processors configured to:
provide remote access for a session to a cloud entity using a child browser window;
receive a message from the child browser window, the message comprising an unique identifier for the child browser window and information pertaining to the session; and
update a cache associated with a main browser window based at least in part on the unique identifier and the information pertaining to the session; and
a memory coupled to the one or more processors and configured to provide the one or more processors with instructions.

22. The system of claim 21, wherein updating the cache includes deleting an entry for the child browser window in response to determining that the information pertaining to the session indicates that the session is terminated.

23. The system of claim 21, wherein the information pertaining to the session includes user activity information, and updating the cache includes storing user activity information in association with one or more of the session or the child browser window.

24. A method, comprising:
providing remote access for a session to a cloud entity using a child browser window;
receiving a message from the child browser window, the message comprising an unique identifier for the child browser window and information pertaining to the session; and
updating a cache associated with a main browser window based at least in part on the unique identifier and the information pertaining to the session.
